(19) United States
(12) Patent Application Publication
(10) Pub. No.: US 2026/0191300 A1
(43) Pub. Date: Jul. 9, 2026

(54) SYSTEM AND METHOD FOR PREDICTING SHOE TRACTION USING COMPUTER VISION

(71) Applicant: UNIVERSITY OF PITTSBURGH - OF THE COMMONWEALTH SYSTEM OF HIGHER EDUCATION, Pittsburgh, PA (US)

(72) Inventors: Gerard ARISTIZÁBAL PLA, Pittsburgh, PA (US); Kurt E. BESCHORNER, Pittsburgh, PA (US)

(73) Assignee: UNIVERSITY OF PITTSBURGH - OF THE COMMONWEALTH SYSTEM OF HIGHER EDUCATION, Pittsburgh, PA (US)

(21) Appl. No.: 19/437,834

(22) Filed: Dec. 31, 2025

Related U.S. Application Data
(60) Provisional application No. 63/742,699, filed on Jan. 7, 2025.

(51) Int. Cl. A43D 1/08; G06N 20/00

(52) U.S. Cl. CPC A43D 1/08; G06N 20/00

(57) ABSTRACT

In one embodiment, a method includes accessing an image depicting a portion of a shoe and a background of the shoe, segmenting the portion of the shoe from the background by machine-learning models, extracting features configured for traction prediction by the machine-learning models, and determining a traction performance associated with the shoe based on the extracted feature by the machine-learning models.

### CROSS-REFERENCE TO RELATED APPLICATIONS

This application claims the benefit of priority of U.S. Provisional Patent Application No. 63/742,699, filed Jan. 7, 2025, the content of which is incorporated herein by reference in its entirety, and to which priority is claimed.

### STATEMENT REGARDING FEDERALLY-SPONSORED RESEARCH

This invention was made with government support under R01 OH010940 awarded by the Centers for Disease Control and Prevention. The government has certain rights in the invention.

### TECHNICAL FIELD

This disclosure generally relates to computer vision.

### BACKGROUND

Shoe traction refers to the grip or friction a shoe sole provides when in contact with a surface. It determines how well the shoe can prevent slipping or sliding, especially on smooth, wet, or uneven surfaces.

Computer vision tasks include methods for acquiring, processing, analyzing, and understanding digital images, and extraction of high-dimensional data from the real world to produce numerical or symbolic information, e.g., in the form of decisions. “Understanding” in this context signifies the transformation of visual images into descriptions of the world that make sense to thought processes and can elicit appropriate action. This image understanding can be seen as the disentangling of symbolic information from image data using models constructed with the aid of geometry, physics, statistics, and learning theory.

### SUMMARY OF PARTICULAR EMBODIMENTS

The purpose and advantages of the disclosed subject matter will be set forth in and apparent from the description that follows, as well as will be learned by practice of the disclosed subject matter. Additional advantages of the disclosed subject matter will be realized and attained by the methods and systems particularly pointed out in the written description and claims hereof, as well as from the appended drawings.

To achieve these and other advantages, and in accordance with the purpose of the disclosed subject matter, as embodied and broadly described, the disclosed subject matter presents systems, methods, and apparatuses that can be used to predict traction performance of shoes. For example, certain non-limiting embodiments can be used to analyze an image of a shoe and predict the traction performance of the shoe based on the analysis.

In certain non-limiting embodiments, one or more computing systems can access an image depicting a portion of a shoe and a background of the shoe. The computing systems can then segment, by one or more machine-learning models, the portion of the shoe from the background. The computing systems can then extract, by the machine-learning models, a plurality of features configured for traction prediction. The computing systems can further determine, based on the extracted feature by the one or more machine-learning models, a traction performance associated with the shoe.

In certain non-limiting embodiments, one or more computer-readable non-transitory storage media embodying software is operable when executed to access an image depicting a portion of a shoe and a background of the shoe. The computer-readable non-transitory storage media embodying software is further operable when executed to segment, by one or more machine-learning models, the portion of the shoe from the background. The computer-readable non-transitory storage media embodying software is further operable when executed to extract, by the machine-learning models, a plurality of features configured for traction prediction. The computer-readable non-transitory storage media embodying software is further operable when executed to determine, based on the extracted feature by the one or more machine-learning models, a traction performance associated with the shoe.

In certain non-limiting embodiments, a system can comprise one or more processors and a non-transitory memory coupled to the processors comprising instructions executable by the processors. The processors are operable when executing the instructions to access an image depicting a portion of a shoe and a background of the shoe. The processors are further operable when executing the instructions to segment, by one or more machine-learning models, the portion of the shoe from the background. The processors are further operable when executing the instructions to extract, by the machine-learning models, a plurality of features configured for traction prediction. The processors are further operable when executing the instructions to determine, based on the extracted feature by the one or more machine-learning models, a traction performance associated with the shoe.

Furthermore, the disclosed embodiments of the methods, computer readable non-transitory storage media, and systems can have further non-limiting features as described below.

In certain non-limiting embodiments, the computing systems can further generate one or more visualizations associated with the spatial transcriptomic dataset. The computing systems can then send, to the client system, instructions for presenting the visualizations.

In certain non-limiting embodiments, the features can include one or more of a size of a worn region, a pressure distribution, a surface area, a heel shape, or a tread geometric feature.

In certain non-limiting embodiments, the computing systems can determine the shoe has a worn region. The computing systems can then segment the worn region from the portion of the shoe in the image. The computing systems can further determine a size of the worn region, wherein the features comprise the size of the worn region.

In certain non-limiting embodiments, the computing systems can further predict, by analyzing the segmented worn region using the machine-learning models, a fluid pressure associated with the shoe. The computing systems can then determine the traction performance associated with the shoe further based on the predicted fluid pressure.

In certain non-limiting embodiments, the computing systems can further identify, by the machine-learning models, a contact region of the shoe. The computing systems can then predict a pressure distribution associated with the contact region, wherein the features comprise the pressure distribution.

In certain non-limiting embodiments, the computing systems can further predict, by a mechanics model, contact mechanics of an interface between the shoe and a ground. The computing systems can then determine the traction performance associated with the shoe further based on the contact mechanics.

In certain non-limiting embodiments, the computing systems can further predict user biomechanics associated with the shoe based on the traction perform.

In certain non-limiting embodiments, the computing systems can further predict a stage change of the shoe associated with a usage of the shoe over time, wherein the stage change indicates a degradation progress associated with the structural and material properties associated with the shoe.

In certain non-limiting embodiments, one or more computing systems can generate enhanced outsole details associated with the shoe by pre-processing the image using a contrast-limited adaptive histogram equalization algorithm.

In certain non-limiting embodiments, one or more computing systems can predict a slip risk associated with the shoe based on the determined traction performance. The slip risk can include a probability. The computing systems can determine the probability is greater than a threshold. The computing systems can then generate an alert indicting the slip risk. The computing systems can further present the alert via a user interface.

It is to be understood that both the foregoing general description and the following detailed description are exemplary and are intended to provide further explanation of the disclosed subject matter claimed. These and other features, aspects, and advantages of the disclosure will be apparent from a reading of the following detailed description together with the accompanying drawings, which are briefly described below. The invention includes any combination of two, three, four, or more of the above-noted embodiments as well as combinations of any two, three, four, or more features or elements set forth in this disclosure, regardless of whether such features or elements are expressly combined in a specific embodiment description herein. This disclosure is intended to be read holistically such that any separable features or elements of the disclosed invention, in any of its various aspects and embodiments, should be viewed as intended to be combinable unless the context clearly dictates otherwise.

### BRIEF DESCRIPTION OF THE DRAWINGS

FIG. 1 illustrates an example flow diagram for predicting shoe traction performance by analyzing an image depicting a shoe using machine-learning models.

FIG. 2A illustrates an example raw smartphone image of a shoe.

FIG. 2B illustrates an example filtered distinguished outsole image of the shoe in FIG. 2A.

FIG. 2C illustrates an example distinguished worn regions from the outsole of the shoe in FIG. 2A.

FIG. 2D illustrates example fluid pressure predictions from the largest worn region for the shoe in FIG. 2A.

FIG. 3 illustrates an example flow diagram for combining an image of the shoe outsole with kinetic and kinematic measures to predict the contact region of the shoe and then predict contact pressures.

FIG. 4 illustrates an example method for predicting shoe traction performance.

FIG. 5 illustrates an example computer system.

### DETAILED DESCRIPTION

Slips and falls remain a leading cause of workplace injuries. Worn shoe outsoles alter tread geometry, leading to elevated fluid pressures at the shoe-floor interface and an increased likelihood of slipping. Current methods for assessing shoe slip risk are often costly or impractical for routine use. Images captured via smartphones provide a practical and affordable method for evaluating slip risk in worn footwear. The embodiments disclosed herein can advance the use of smartphones for assessing shoe slip risk by: (1) assessing the accuracy of a series of convolutional networks in automatically identifying the largest worn region from phone images, and (2) investigating the association between predicted peak fluid pressures from the largest worn regions and experimentally-measured peak fluid pressures, coefficient of friction, and friction loss (i.e., percent coefficient of friction relative to baseline).

In certain non-limiting embodiments, based on an image depicting a shoe, a computing system can use a sequence of computer vision techniques to predict tread features and mechanics responses on shoe tread to predict friction performance. The computing system can further provide diagnostic feedback on how shoe tread design influences friction performance. In an example embodiment, the computing system can segment the shoe from its background in the picture, segment the regions or probabilistically predict the regions of the shoe or features of the shoe that are expected to contact the ground during walking. The computing system can then predict the impact of the shoe treads on friction performance, either by predicting the contact mechanics of the shoe-ground interface (e.g., force or pressure distribution across treads) or by identifying features of the tread associated with good friction performance (e.g., smaller treads provide better fluid drainage). Based on the identified physics and shoe characteristics, the computing system can develop an overall prediction of the shoe's friction performance.

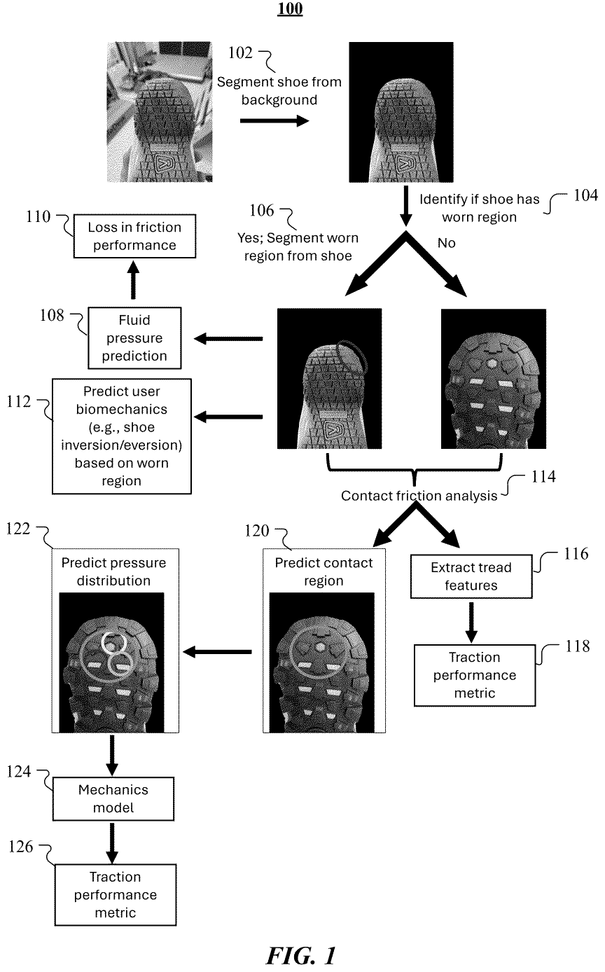

FIG. 1 illustrates an example flow diagram 100 for predicting shoe traction performance by analyzing an image depicting a shoe using machine-learning models. The image can be a raw image of the shoe outsole. At step 102, the computing system can segment the shoe from the background of the shoe. The segmentation can be conducted by one or more machine-learning models such as a segmentation model. In certain non-limiting embodiments, convolutional neural networks (CNN) can be utilized. For example, the computing system can use CNN to isolate the shoe outsole from the background in the picture.

At step 104, the computing system can identify if the shoe has a worn region using the machine-learning models. As an example and not by way of limitation, identifying the worn region can be based on an object classification/detection model. In certain non-limiting embodiments, convolutional neural networks (CNN) can be utilized.

If the shoe has a worn region, the computing system can further segment the worn region from the shoe at step 106 using the segmentation model. If the shoe does not have a worn region, the computing system can perform contact friction/traction analysis at step 114.

At step 108, the computing system can conduct fluid pressure prediction by analyzing the worn region using the machine-learning models. Higher predicted peak fluid pressures can be associated with higher experimental peak fluid pressures and lower coefficient of friction values.

At step 110, the computing system can predict the loss in friction/traction performance based on flue pressure prediction using the machine-learning models.

At step 112, the computing system can predict user biomechanics based on the worn region using the machine-learning models. For example, the user biomechanics can include shoe inversion, shoe eversion, etc.

The flow diagram 100 then proceeds to step 114, where the computing system can perform contact friction/traction analysis.

The contact friction/traction analysis can also include step 116 and step 118.

At step 116, the computing system can extract tread features associated with the shoe using the machine-learning models. As an example and not by way of limitation, the tread features can include one or more of surface area, heel shape, or tread geometric feature.

At step 118, the computing system can predict traction performance metric based on the tread features using the machine-learning models.

The contact friction/traction analysis can include step 120, where the computing system can predict the contact region using the machine-learning models. In certain non-limiting embodiments, the contact region can include the shoe's outsole, which is the portion that contacts the ground when a user wearing the shoe walks.

At step 122, the computing system can predict pressure distribution on the contact region using the machine-learning models. For example, as illustrated in FIG. 1, the contact region can include a plurality of lugs. The computing system can predict the pressure distribution for each lug. Red circles represent lugs with maximum pressure, yellow circles represent lugs with medium pressure and green circles represent lugs with minimum pressure.

At step 124, the computing system can generate a mechanics model based on the predicted pressure distribution.

At step 126, the computing system can determine the traction performance metric based on the mechanics model. In certain non-limiting embodiments, the mechanics model can have characterized coefficient of friction as a function of pressure. Once the pressure is known, the coefficient of friction can be calculated across the surface. The contact pressure and the pressure-dependent coefficient of friction can be used to calculate the shear stress. Then the overall coefficient of friction for the shoe can be calculated by integrating the shear stress to determine the overall friction force and the normal force. In certain non-limiting embodiments, the traction performance metric can include a coefficient friction value. In certain non-limiting embodiments, the computing system can further predict how the shoe will wear down over time based on the pressure distribution.

In certain non-limiting embodiments, the computing system can determine the final predicted traction performance metric based on one or more of the predicted loss in friction performance, the traction performance metric determined using the tread features, or the traction performance metric determined based on the pressure distribution.

Although this disclosure describes particular traction predictions using particular models in particular manners, this disclosure contemplates any suitable traction prediction using any suitable model in any suitable manner. In certain non-limiting embodiments, the traction prediction can be based on a traction prediction algorithm that can be flexibly designed. The traction prediction algorithm can accept inputs that include extracted features of the tread, physics-based predictions (including but not limited to contact or fluid pressures), and user-input characteristics (e.g., material information). The traction prediction algorithm can take the form of a physics-based model, a statistics model, a machine-learning model, or a combination of one or more of these models.

As described above, the computing system can use machine-learning models for different tasks associated with shoe traction performance prediction. For example, the computing system can use the machine-learning models to segment the shoe from its background. In this scenario, the machine-learning models can include segmentation models trained to segment a shoe from its background. The computing system can train the segmentation models based on a plurality of training images. In certain non-limiting embodiments, the training images can include annotated images where each pixel is labeled with its corresponding class (e.g., shoe). The label can function as a ground truth mask that tells the segmentation model which pixels belong to which object within the image, allowing the segmentation model to learn the boundaries and characteristics of shoes for accurate segmentation. In certain non-limiting embodiments, a segmentation model based on CNN can be trained using the process of generating a segmentation network, training the segmentation network, evaluation the segmentation results on validation data, and updating the segmentation network based on the evaluation.

As another example, the computing system can use the machine-learning models to identify if the shoe has a worn region. In this scenario, the machine-learning models can include object detection models trained to detect worn regions from shoes. The computing system can train the object detection models based on a plurality of training images. In certain non-limiting embodiments, the training images can include images of shoes with worn regions and images of shoes without worn regions. In certain non-limiting embodiments, an object detection model based on CNN can be trained using the process of generating an object detection network, training the object detection network, evaluation the detection results on validation data, and updating the objection detection network based on the evaluation.

As another example, the computing system can use the machine-learning models for fluid pressure prediction. In this scenario, the machine-learning models can be trained to predict fluid pressure of shoes. The computing system can train the machine-learning models based on a plurality of training images. In certain non-limiting embodiments, the training images can include images of shoes annotated with different levels of fluid pressure. In certain non-limiting embodiments, the machine-learning models for fluid pressure prediction can be based on CNN.

As another example, the computing system can use the machine-learning models for user biomechanics prediction. In this scenario, the machine-learning models can be trained to predict user biomechanics. The computing system can train the machine-learning models based on a plurality of training images. In certain non-limiting embodiments, the training images can include images of shoes annotated with different user biomechanics. In certain non-limiting embodiments, the machine-learning models for fluid pressure prediction can be based on CNN.

As another example, the computing system can use the machine-learning models to predict contact regions. In this scenario, the machine-learning models can be trained to predict contact regions. The computing system can train the machine-learning models based on a plurality of training images. In certain non-limiting embodiments, the training images can include images of shoes annotated with contact regions. In certain non-limiting embodiments, the machine-learning models for contact region prediction can be based on CNN.

As another example, the computing system can use the machine-learning models to predict pressure distribution. In this scenario, the machine-learning models can be trained to predict pressure distribution. The computing system can train the machine-learning models based on a plurality of training images. In certain non-limiting embodiments, the training images can include images of contact regions of shoes annotated with pressure distributions. In certain non-limiting embodiments, the machine-learning models for pressure distribution prediction can be based on CNN.

As another example, the computing system can use the machine-learning models to determine traction performance metric based on tread features. The computing system can train the machine-learning models based on a plurality of training images. In certain non-limiting embodiments, the training images can include images of shoes annotated with different traction performance metrics. In certain non-limiting embodiments, the machine-learning models for determining traction performance metric based on tread features can be based on CNN.

In certain non-limiting embodiments, a series of convolutional networks, namely two U-Nets and a Resnet-50 are used for automatically identifying the largest worn region from phone images. In experimental evaluations, fifteen participants wore two distinct pairs of shoes with varying tread patterns in their workplaces. Each pair was worn for one month at a time. The coefficient of friction was assessed at baseline and after each month of wear using a slip tester. Peak fluid pressures were simultaneously measured with an array of fluid pressure sensors embedded in the floor of the slip tester. Images of shoes (902 images) were taken with a smartphone. Ground-truth masks were generated using a polygon tool and converted into binary masks. A U-Net was trained on 449 images to automate the shoe outsole detection from the background. A Resnet-50 was then trained on 700 images (350 worn, 350 new, unmatched pairs) to classify the shoes in being either worn or new. Finally, a U-Net was trained on 202 images from a publicly available dataset to automate the worn region detection for shoes that were classified as worn using data augmentation techniques (e.g., rotations, horizontal flips). Images were first pre-processed using contrast-limited adaptive histogram equalization technique to enhance outsole details. U-Net and Resnet-50 model performances were assessed using 80% of the data for training, 10% of the data for validating and 10% of the data for testing.

To investigate the association between predicted peak fluid pressures from the largest worn regions and experimentally measured peak fluid pressures, coefficient of friction, and friction loss, 119 images of worn shoes were used to create ground-truth masks of the largest worn regions. These masks of the largest worn regions were input into a numerical solver of Reynolds' Equation to simulate fluid pressure dynamics between contacting surfaces.

The U-Net performance was visually inspected. The Resnet-50 performance was evaluated using accuracy. Simple linear regressions were conducted to explore relationships between predicted peak fluid pressures and experimental peak fluid pressures (square root transformation), coefficient of friction values and friction loss (log transformation).

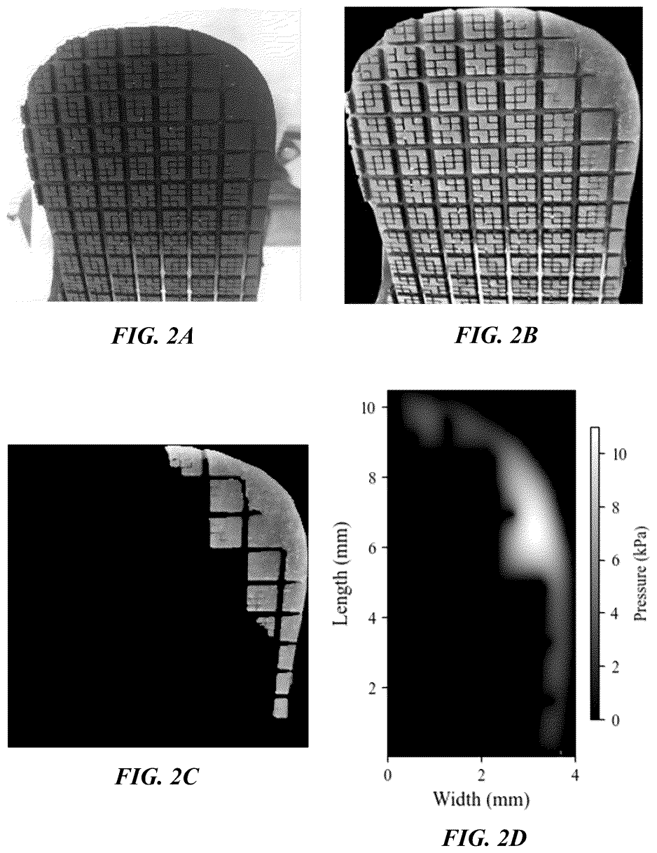

FIG. 2A illustrates an example raw smartphone image of a shoe. FIG. 2B illustrates an example filtered distinguished outsole image of the shoe in FIG. 2A. FIG. 2C illustrates an example distinguished worn regions from the outsole of the shoe in FIG. 2A. FIG. 2D illustrates example fluid pressure predictions from the largest worn region for the shoe in FIG. 2A. The first U-Net successfully distinguished shoe outsoles from the backgrounds. Representative model predictions for a sample image are shown in FIG. 2B. The Resnet-50 was able to classify shoes in being worn or new with an accuracy of 96%. Finally, the last U-Net was able to successfully distinguish worn regions from the outsoles. Representative model predictions for a sample image are shown in FIG. 2C. The convolutional networks demonstrated their potential in automatically identifying worn regions. The performance of the networks could be enhanced with additional phone images, as we had a limited data set consisting of only 902 images.

Higher predicted peak fluid pressures were associated with higher experimental peak fluid pressures, lower coefficient of friction values and increased friction loss. The assumption that the entire worn region was in contact with the ground can have contributed to lower predictive ability of the models. Representative fluid pressure predictions are shown in FIG. 2D.

The experimental evaluations demonstrate the feasibility of using smartphones combined with convolutional networks and fluid modeling to automate the worn region analysis and predict fluid pressures in worn shoes. The embodiments disclosed herein can be implemented and executed on a mobile device such as a smart phone. The embodiments disclosed herein establish a link between predicted fluid pressures and coefficient of friction, offering an approach to assessing traction performance and slip risk.

In certain non-limiting embodiments, the computing system can predict a slip risk associated with the shoe based on the determined traction performance. The slip risk can be probability. If the probability is greater than a threshold, the computing system can generate an alert and present the alert via a user interface. The user interface can execute on a mobile device such as a smart phone.

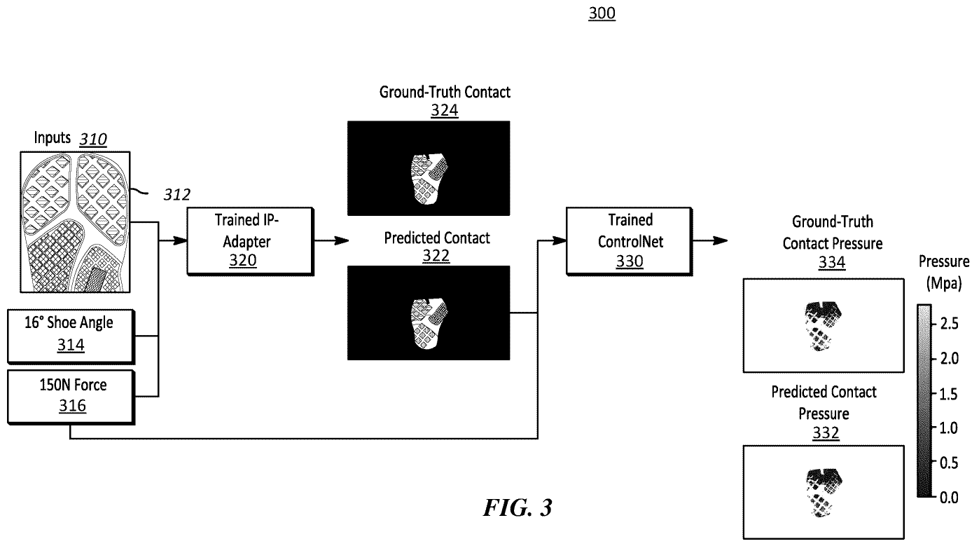

FIG. 3 illustrates an example flow diagram 300 for combining an image of the shoe outsole with kinetic and kinematic measures to predict the contact region of the shoe and then predict contact pressures. Diffusion models have demonstrated robust performance in image generation using flexible input prompts. However, their application in biomechanics—where outputs need to adhere to physical realism-remains a technical challenge. One important biomechanical metric is shoe-ground contact mechanics, which influences user performance and safety. In certain non-limiting embodiments, the computing system can utilize diffusion models to predict shoe-tread contact pressure distributions using data derived from frustrated total internal reflection (FTIR) imaging.

The flow diagram 300 represents a two-stage generative process for predicting shoe-ground contact mechanics using diffusion models. The flow diagram 300 begins with inputs 310 including an image 312 of the shoe outsole, along with biomechanical parameters such as kinematic measures and Kinect measures. For example, a kinematic measure can be a shoe angle (e.g., 16°) 314 and a Kinect measure can be a vertical force 316 (e.g., 150N). These inputs 310 provide both visual and physical context for the prediction task.

The first stage uses a trained IP-Adapter model 320, which is a fine-tuned diffusion-based architecture. This model 320 takes the outsole image 312 and biomechanical inputs to predict a contact mask 322, identifying the regions of the shoe outsole expected to make contact with the ground. The predicted contact mask 322 is compared against ground-truth contact data 324 obtained from FTIR imaging to evaluate accuracy.

In the second stage, the predicted contact mask 322 and force input 316 are passed to a trained ControlNet model 330. The ControlNet model 330 generates a pressure distribution map 332 that represents localized pressures within the contact regions. This output 332 is compared to ground-truth pressure maps 334 derived from FTIR calibration, typically evaluated using metrics such as mean absolute error.

Together, these two models form a hierarchical pipeline: IP-Adapter 320 predicts where contact occurs, and ControlNet 330 predicts how pressure is distributed across those regions. This approach enables biomechanically realistic predictions by combining visual cues with physics-informed modeling.

In experiments of certain embodiments, pressure maps were captured for 10 different shoes under varying angles and force levels using an FTIR-based calibration method that converts pixel intensities to vertical force, resulting in approximately 1,500 frames of data. In certain non-limiting embodiments, the computing system can obtain image intensity distribution for the contact region (I(x) versus x, where x goes from 0 to Xₙ, the last pixel in the image) from an FTIR image. The computing system can flatten a two-dimensional (2D) image array so it becomes a one-dimensional (1D) array.

Since

$$p = β \cdot {( x , y )}^{3} , \qquad ( 1 )$$

force can be calculated as the integral of pressure:

$$F = {\int }_{0}^{{X}_{n}} β \cdot {I ( x , y )}^{3} dA . \qquad ( 2 )$$

Resolving the integration will give:

$$F = β \cdot G = β \cdot {\int }_{0}^{{X}_{n}} {I ( x , y )}^{3} dA . \qquad ( 3 )$$

In addition, β can be obtained. Once β is available, the computing system can get pressure using equation (1). If subsequently integrating p over the pixel values, one can get:

$${F}_{est} = {\int }_{0}^{{x}_{n}} p d x \qquad ( 4 )$$

For generative modeling, two large Stable Diffusion-based architectures (≈860M parameters each), ControlNet and IP-Adapter, were fine-tuned. IP-Adapter predicted contact masks from smartphone outsole images, foot angles, and vertical forces, evaluated using Dice score, while ControlNet generated pressure distributions from contact masks and force inputs, evaluated using mean absolute error (MAE). Fine-tuning was performed by training only LoRA adapters attached to U-Net attention layers (≈5-8M trainable parameters), while base diffusion weights and the VAE remained frozen. All models were trained and validated using leave-one-shoe-out cross-validation to assess generalization to unseen footwear and loading conditions, with each fold trained for 30 epochs (~20,000 optimization steps). To incorporate biomechanical context, the U-Net was conditioned on force and foot-angle scalars via positional encodings.

The FTIR intensity-to-force calibration achieved an average R² of 0.97. Across ten folds, ControlNet produced pressure maps with a mean MAE of 2 kPa, and IP-Adapter generated contact masks with a mean Dice score of 0.61. These results indicate that the disclosed sequence of diffusion models can accurately predict contact regions and pressures within these regions. ControlNet learned to generate physically consistent pressure maps, while IP-Adapter inferred contact regions from readily available visual and biomechanical inputs. Together, these experimental evaluations demonstrate that diffusion models can produce biomechanically realistic outputs across diverse footwear conditions.

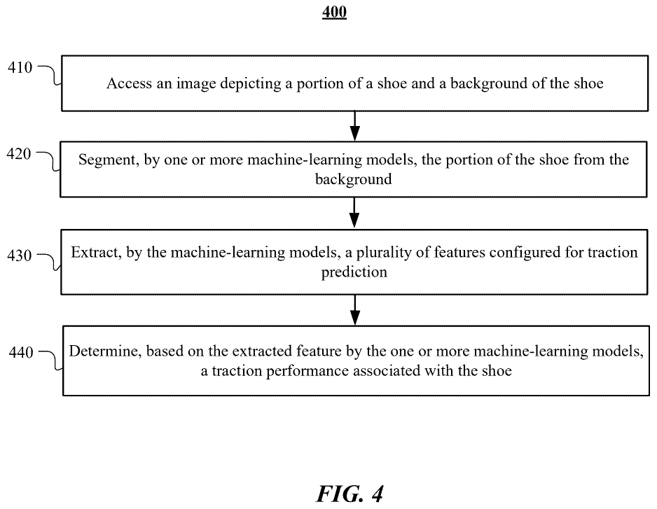

FIG. 4 illustrates an example method 400 for predicting shoe traction performance. The method can begin at step 410, where the computing system can access an image depicting a portion of a shoe and a background of the shoe. At step 420, the computing system can segment, by one or more machine-learning models, the portion of the shoe from the background. At step 430, the computing system can extract, by the machine-learning models, a plurality of features configured for traction prediction. At step 440, the computing system can determine, based on the extracted feature by the one or more machine-learning models, a traction performance associated with the shoe. Particular embodiments can repeat one or more steps of the method of FIG. 4, where appropriate. Although this disclosure describes and illustrates particular steps of the method of FIG. 4 as occurring in a particular order, this disclosure contemplates any suitable steps of the method of FIG. 4 occurring in any suitable order. Moreover, although this disclosure describes and illustrates an example method for predicting shoe traction performance including the particular steps of the method of FIG. 4, this disclosure contemplates any suitable method for predicting shoe traction performance including any suitable steps, which can include all, some, or none of the steps of the method of FIG. 4, where appropriate. Furthermore, although this disclosure describes and illustrates particular components, devices, or systems carrying out particular steps of the method of FIG. 4, this disclosure contemplates any suitable combination of any suitable components, devices, or systems carrying out any suitable steps of the method of FIG. 4.

Although the embodiments disclosed herein focus on predicting shoe traction performance, the embodiments disclosed herein can be applied to any suitable prediction of traction performance. In one example use case, the embodiments disclosed herein can be applied to predicting tire (such as car tires, bike tires, scooter tires, etc.) traction performance. In particular embodiments, the computer system can access an image depicting a tire. The computer system can segment the tire from the background of the tire using the disclosed machine-learning models. The computer system can then identify if the tire has a worn region using the disclosed machine-learning models. If the tire has a worn region, the computing system can further segment the worn region from the tire using the disclosed segmentation model. The computing system can conduct fluid pressure prediction by analyzing the worn region using the disclosed machine-learning models and predict the loss in friction/traction performance based on flue pressure prediction using the disclosed machine-learning models. If the tire does not have a worn region or after predicting the loss in friction/traction performance based on the worn region, the computing system can perform contact friction/traction analysis. In particular embodiments, the computing system can extract tread features associated with the tire using the disclosed machine-learning models. The computing system can then predict traction performance metric based on the tread features using the disclosed machine-learning models. The contact friction/traction analysis can include predicting the contact region of the tire using the disclosed machine-learning models. The computing system can then predict pressure distribution on the contact region using the disclosed machine-learning models. The computing system can generate a mechanics model based on the predicted pressure distribution. The computing system can determine the traction performance metric based on the mechanics model. The computing system can further determine the final predicted traction performance metric of the tire based on one or more of the predicted loss in friction performance, the traction performance metric determined using the tread features, or the traction performance metric determined based on the pressure distribution.

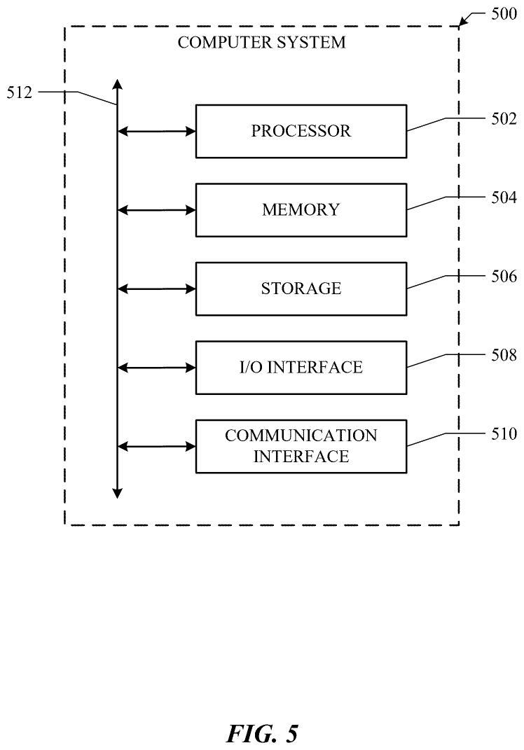

FIG. 5 illustrates an example computer system 500. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500. Herein, reference to a computer system can encompass a computing device, and vice versa, where appropriate. Moreover, reference to a computer system can encompass one or more computer systems, where appropriate.

This disclosure contemplates any suitable number of computer systems 500. This disclosure contemplates computer system 500 taking any suitable physical form. As example and not by way of limitation, computer system 500 can be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 500 can include one or more computer systems 500; be unitary or distributed; span multiple locations; span multiple machines; span multiple data centers; or reside in a cloud, which can include one or more cloud components in one or more networks. Where appropriate, one or more computer systems 500 can perform without substantial spatial or temporal limitation one or more steps of one or more methods described or illustrated herein. As an example and not by way of limitation, one or more computer systems 500 can perform in real time or in batch mode one or more steps of one or more methods described or illustrated herein. One or more computer systems 500 can perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 can retrieve (or fetch) the instructions from an internal register, an internal cache, memory 504, or storage 506; decode and execute them; and then write one or more results to an internal register, an internal cache, memory 504, or storage 506. In particular embodiments, processor 502 can include one or more internal caches for data, instructions, or addresses. This disclosure contemplates processor 502 including any suitable number of any suitable internal caches, where appropriate. As an example and not by way of limitation, processor 502 can include one or more instruction caches, one or more data caches, and one or more translation lookaside buffers (TLBs). Instructions in the instruction caches can be copies of instructions in memory 504 or storage 506, and the instruction caches can speed up retrieval of those instructions by processor 502. Data in the data caches can be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches can speed up read or write operations by processor 502. The TLBs can speed up virtual-address translation for processor 502. In particular embodiments, processor 502 can include one or more internal registers for data, instructions, or addresses. This disclosure contemplates processor 502 including any suitable number of any suitable internal registers, where appropriate. Where appropriate, processor 502 can include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 can load instructions from storage 506 or another source (such as, for example, another computer system 500) to memory 504. Processor 502 can then load the instructions from memory 504 to an internal register or internal cache. To execute the instructions, processor 502 can retrieve the instructions from the internal register or internal cache and decode them. During or after execution of the instructions, processor 502 can write one or more results (which can be intermediate or final results) to the internal register or internal cache. Processor 502 can then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which can each include an address bus and a data bus) can couple processor 502 to memory 504. Bus 512 can include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM can be volatile memory, where appropriate. Where appropriate, this RAM can be dynamic RAM (DRAM) or static RAM (SRAM). Moreover, where appropriate, this RAM can be single-ported or multi-ported RAM. This disclosure contemplates any suitable RAM. Memory 504 can include one or more memories 504, where appropriate. Although this disclosure describes and illustrates particular memory, this disclosure contemplates any suitable memory.

In particular embodiments, storage 506 includes mass storage for data or instructions. As an example and not by way of limitation, storage 506 can include a hard disk drive (HDD), a floppy disk drive, flash memory, an optical disc, a magneto-optical disc, magnetic tape, or a Universal Serial Bus (USB) drive or a combination of two or more of these. Storage 506 can include removable or non-removable (or fixed) media, where appropriate. Storage 506 can be internal or external to computer system 500, where appropriate. In particular embodiments, storage 506 is non-volatile, solid-state memory. In particular embodiments, storage 506 includes read-only memory (ROM). Where appropriate, this ROM can be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 can include one or more storage control units facilitating communication between processor 502 and storage 506, where appropriate. Where appropriate, storage 506 can include one or more storages 506. Although this disclosure describes and illustrates particular storage, this disclosure contemplates any suitable storage.

In particular embodiments, I/O interface 508 includes hardware, software, or both, providing one or more interfaces for communication between computer system 500 and one or more I/O devices. Computer system 500 can include one or more of these I/O devices, where appropriate. One or more of these I/O devices can enable communication between a person and computer system 500. As an example and not by way of limitation, an I/O device can include a keyboard, keypad, microphone, monitor, mouse, printer, scanner, speaker, still camera, stylus, tablet, touch screen, trackball, video camera, another suitable I/O device or a combination of two or more of these. An I/O device can include one or more sensors. This disclosure contemplates any suitable I/O devices and any suitable I/O interfaces 508 for them. Where appropriate, I/O interface 508 can include one or more device or software drivers enabling processor 502 to drive one or more of these I/O devices. I/O interface 508 can include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 can include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 can communicate with an ad hoc network, a personal area network (PAN), a local area network (LAN), a wide area network (WAN), a metropolitan area network (MAN), or one or more portions of the Internet or a combination of two or more of these. One or more portions of one or more of these networks can be wired or wireless. As an example, computer system 500 can communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 can include any suitable communication interface 510 for any of these networks, where appropriate. Communication interface 510 can include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 can include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 512 can include one or more buses 512, where appropriate. Although this disclosure describes and illustrates a particular bus, this disclosure contemplates any suitable bus or interconnect.

Herein, a computer-readable non-transitory storage medium or media can include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium can be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments can include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments can provide none, some, or all of these advantages.

What is claimed is:

1. A method comprising, by one or more computing systems:
accessing an image depicting a portion of a shoe and a background of the shoe;
segmenting, by one or more machine-learning models, the portion of the shoe from the background;
extracting, by the machine-learning models, a plurality of features configured for traction prediction; and
determining, based on the extracted feature by the one or more machine-learning models, a traction performance associated with the shoe.

2. The method of claim 1, wherein the features comprise one or more of a size of a worn region, a pressure distribution, a surface area, a heel shape, or a tread geometric feature.

3. The method of claim 1, further comprising:
determining the shoe has a worn region;
segmenting the worn region from the portion of the shoe in the image; and
determining a size of the worn region, wherein the features comprise the size of the worn region.

4. The method of claim 3, further comprising:
predicting, by analyzing the segmented worn region using the machine-learning models, a fluid pressure associated with the shoe; and
determining the traction performance associated with the shoe further based on the predicted fluid pressure.

5. The method of claim 1, further comprising:
identifying, by the machine-learning models, a contact region of the shoe; and
predicting a pressure distribution associated with the contact region, wherein the features comprise the pressure distribution.

6. The method of claim 1, further comprising:
predicting, by a mechanics model, contact mechanics of an interface between the shoe and a ground; and
determining the traction performance associated with the shoe further based on the contact mechanics.

7. The method of claim 1, further comprising:
predicting user biomechanics associated with the shoe based on the traction performance.

8. The method of claim 1, further comprising:
predicting a stage change of the shoe associated with a usage of the shoe over time, wherein the stage change indicates a degradation progress associated with the structural and material properties associated with the shoe.

9. The method of claim 1, further comprising:
generating enhanced outsole details associated with the shoe by pre-processing the image using a contrast-limited adaptive histogram equalization algorithm.

10. The method of claim 1, further comprising:
predicting a slip risk associated with the shoe based on the determined traction performance.

11. The method of claim 10, wherein the slip risk comprises a probability, the method further comprising:
determining the probability is greater than a threshold;
generating an alert indicting the slip risk; and
presenting the alert via a user interface.

12. One or more computer-readable non-transitory storage media embodying software that is operable when executed to:
access an image depicting a portion of a shoe and a background of the shoe;
segment, by one or more machine-learning models, the portion of the shoe from the background;
extract, by the machine-learning models, a plurality of features configured for traction prediction; and
determine, based on the extracted feature by the one or more machine-learning models, a traction performance associated with the shoe.

13. The media of claim 12, wherein the features comprise one or more of a size of a worn region, a pressure distribution, a surface area, a heel shape, or a tread geometric feature.

14. The media of claim 12, wherein the software is further operable when executed to:
determine the shoe has a worn region;
segment the worn region from the portion of the shoe in the image; and
determine a size of the worn region, wherein the features comprise the size of the worn region.

15. The media of claim 14, wherein the software is further operable when executed to:
predict, by analyzing the segmented worn region using the machine-learning models, a fluid pressure associated with the shoe; and
determine the traction performance associated with the shoe further based on the predicted fluid pressure.

16. The media of claim 12, wherein the software is further operable when executed to:
identify, by the machine-learning models, a contact region of the shoe; and
predict a pressure distribution associated with the contact region, wherein the features comprise the pressure distribution.

17. The media of claim 12, wherein the software is further operable when executed to:
predict, by a mechanics model, contact mechanics of an interface between the shoe and a ground; and
determine the traction performance associated with the shoe further based on the contact mechanics.

18. The media of claim 12, wherein the software is further operable when executed to:
predict user biomechanics associated with the shoe based on the traction perform.

19. The media of claim 12, wherein the software is further operable when executed to:
predict a stage change of the shoe associated with a usage of the shoe over time, wherein the stage change indicates a degradation progress associated with the structural and material properties associated with the shoe.

20. A system comprising: one or more processors; and a non-transitory memory coupled to the processors comprising instructions executable by the processors, the processors operable when executing the instructions to:
access an image depicting a portion of a shoe and a background of the shoe;
segment, by one or more machine-learning models, the portion of the shoe from the background;
extract, by the machine-learning models, a plurality of features configured for traction prediction; and
determine, based on the extracted feature by the one or more machine-learning models, a traction performance associated with the shoe.
